(19) United States
(12) Patent Application Publication
(10) Pub. No.: US 2026/0109622 A1
(43) Pub. Date: Apr. 23, 2026

(54) LITHIUM NICKEL MANGANESE PHOSPHATE CATHODE MATERIAL AND PREPARATION METHOD THEREOF

(71) Applicant: Hubei Gaobo Technology Co., Ltd., Jingzhou (CN)

(72) Inventor: Kaijun CHANG, Yichang (CN)

(21) Appl. No.: 19/385,698

(22) Filed: Nov. 11, 2025

Related U.S. Application Data
(63) Continuation of application No. PCT/CN2024/083940, filed on Mar. 27, 2024.

(30) Foreign Application Priority Data
Jun. 12, 2023 (CN) 202310690990.5

(51) Int. Cl. C01G 53/82

(52) U.S. Cl. CPC C01G 53/82; C01P 2004/51; C01P 2004/61; C01P 2006/22; C01P 2006/40

(57) ABSTRACT

An olivine-structured nickel manganese phosphate active material includes a general structural formula of Ni_{b}Mn_{d}MₑPO₄. b is greater than or equal to 0.1 and greater than or equal to 0.95. d is greater than or equal to 0.05 and greater than or equal to 0.90. e is greater than or equal to 0 and greater than or equal to 0.5. A doping element M includes one or a combination of Fe, Al, Co, Ca, Pb, Na, Ti, Zr, Mo, V, Nb, Sc, Cr, Cu, Zn, Be, La, Mg, N, or S.

### CROSS-REFERENCE TO RELATED APPLICATION

This application claims priority to Chinese Patent Application No. 202310690990.5, filed Jun. 12, 2023, the entire content of which is incorporated herein by reference.

### TECHNICAL FIELD

The present disclosure relates to the 5V high-voltage cathode material and the precursor material and, more particularly, to an olivine lithium nickel manganese phosphate cathode material and a preparation method thereof.

### BACKGROUND

The development of electric vehicles has raised requirements on power sources of the electric vehicles, i.e., lithium batteries. An important aspect is that voltage platforms and capacities of lithium batteries need to meet the development requirements of electric vehicles. The existing specific energy of a lithium iron phosphate monomer battery only ranges from 110 to 120 Wh/kg. The density of energy of a battery system is less than 100 Wh/kg even after the lithium iron phosphate monomer batteries are assembled into a battery pack. Although the specific energy of a ternary material is higher than the specific energy of lithium iron phosphate, the ternary material fails to meet the requirements of a traction battery in terms of thermal stability and safety, cycle life, processing difficulty, and cost reduction. Therefore, how to improve the battery capacity and safety, increase the cycle life, reduce the cost, and then to further increase the driving range of the electric vehicles while ensuring safety and optimizing cost-effectiveness are always topics that need to be addressed in the battery industry. The present disclosure provides a new cathode material for a lithium battery to increase the voltage platform, improve thermal stability, increase the cycle life, reduce the cost, and increase the specific energy to increase the driving range of the electric vehicles to improve performance of the traction battery.

### SUMMARY

Given the limitations in the performance and technology of existing lithium batteries, particularly lithium iron phosphate and ternary materials, the present disclosure needs to solve the technical problem and provide a phosphate battery material with a high-voltage platform and higher capacity. The theoretical voltage platform of lithium nickel manganese phosphate (LNMP) of the present disclosure can reach up to 5.1V, while lithium iron phosphate (LiFePO4) only has a voltage platform of only 3.2V, and ternary material 811 has a voltage platform of only 4.2V. In terms of capacity, LNMP can achieve up to 860 WH/Kg, whereas LiFePO4 only has 540 Wh/Kg, resulting in nearly a 50% increase. In the present disclosure, the material can be produced in bulk through a solid-phase method, a gel method, a liquid-phase method, and a hydrothermal method. The raw materials are readily available, and the process can be realized through various approaches. Moreover, the environment temperature and humidity requirements during production are not as stringent as those for high-nickel ternary materials. LNMP positive electrode battery material can achieve high purity, low impurities, and small and uniform particle size. The synthesized LNMP battery can have high specific capacity and excellent rate discharge performance and have similar good performance in high and low temperatures and a cycle numbers to LiFePO4. The voltage platform is far superior to LiFePO4 and ternary materials, and the overall electrical performance is much better than ternary materials.

The purpose of the present disclosure is implemented by a manufacturing method for LNMP positive electrode or precursor material.

### 1. Solid-Phase Method

Positive electrode: Manganese source, nickel source, lithium source, carbon source, phosphorus source, and doping element materials are proportionally added according to the stoichiometric ratio and sufficiently dispersed or refined in a pulverizer or sand mill until the design particle size requirements are reached. Then, spray drying can be performed to perform high-temperature sintering on the dried material in an inert gas-protected furnace for thermal decomposition reactions and phase transitions to obtain to obtain carbon-coated lithium nickel manganese phosphate cathode material (LNMP/C or LNMP@C).

### 2. Liquid-Phase Method/Gel Method

Precursor: Manganese source and nickel source are dissolved thoroughly in a phosphorus source aqueous solution of a certain concentration and filtered, and then alkaline substances are added to adjust the pH for precipitation and crystallization. The slurry is filtered to obtain a filter cake, which is then washed thoroughly with pure water. The filter cake is dried, sintered, and then transformed to obtain NMP-type precursor material.

Positive electrode: the above NMP-type precursor material is measured for composition, and then carbon source, lithium source, and element doping materials are proportionally added according to the chemical stoichiometry. These materials are sanded and dispersed in a sand mill until the design particle size requirements are reached. Then, the spray drying is performed to perform the sintering on the dried material in an inert gas-protected furnace for thermal decomposition reactions and phase transitions to obtain to obtain carbon-coated lithium nickel manganese phosphate cathode material (LNMP/C or LNMP@C).

### 3. Hydrothermal Method or Supercritical Hydrothermal Method

NMP pre-material: Soluble manganese source, nickel source, and phosphorus source are dissolved thoroughly according to the chemical stoichiometry and filtered to obtain a clean solution. The solution undergoes a hydrothermal reaction under certain pressure and temperature conditions in a hot water bath. After a period of OSTWALD reaction, the material is discharged and filtered to obtain the filter cake. The filter cake is then dried, initially crushed, and graded. Through measuring and calculation, a certain amount of nickel source, manganese source, or phosphorus source is added to fine-tune the material to the required material specification, i.e., NMP. The product can continue to be sintered at a high temperature from 200 to 800 degrees to obtain anhydrous NMP.

Positive electrode: Soluble manganese source, nickel source, lithium source, carbon source, phosphorus source, and doping elements are dissolved thoroughly and filtered to obtain a clean solution. The solution undergoes a hydrothermal reaction under certain pressure and temperature conditions in a hot water bath. After a period of OSTWALD reaction, the material is discharged and filtered to obtain the filter cake. The filter cake is then dried, initially crushed, and graded. A certain amount of carbon source and lithium source is added for fine-tuning mixing. Then, the material is sintered and air powdered under the protection of an inert gas to obtain LNMP positive electrode material.

SEM morphology of the precursor NMP obtained in the methods of the present disclosure can be plate-shaped, layered, spherical, olivine-shaped, strip-shaped, or fibrous. The appearance of the precursor NMP is light yellow or yellow-green. However, due to different particle size, morphology, and nickel-manganese content ratio, appearance color can be different. SEM morphology of the prepared LNMP positive electrode material produced has a relatively spherical olivine structure. The product have a The product has a high degree of dispersion and liquidity with a vibration ratio can reach above 0.95 g/cm³, a very low impurity content with S≤50 ppm, Na≤50 ppm, K≤50 ppm, and heavy metals such as Cu, Pb, Cd, and Cr≤10 ppm, Ca, Mg≤50 ppm, and low magnetic materials ≤1 ppm. The voltage platform is around 5.25V, and the 0.1C specific capacity is approximately 160 mAh/g.

The nickel manganese lithium phosphate product of the present disclosure is easy to control in terms of the molar ratio of nickel manganese lithium elements. The ratio of the three elements can be precisely controlled and can be adjusted arbitrarily. The impurity content is low, and the product has high dispersion and fluidity. The vibration ratios are all above 0.95. Particle size distribution is within a narrow range, with D₅₀ being stable at a particle size from 0.5 to 2.0 μm. SEM images show that the appearance of the product is plate-shaped or sheet-shaped with high compressing density. XRD analysis also confirms that the obtained nickel manganese lithium phosphate product is a pure-phase olivine structure product. Through the test of buckling simulated battery made of the material, the voltage platform is approximately around 5.2V, and a 0.1C capacity reaches 160-161.5 mAh/g.

### BRIEF DESCRIPTION OF THE DRAWINGS

The present disclosure is further described in connection with the accompanying drawings and embodiments.

FIG. 1 presents X-ray diffractometer (XRD) diagrams of lithium nickel manganese phosphates consistent with embodiments 1, 2, 3, and 4 of the present disclosure. FIG. 2 presents scanning electron microscopy (SEM) diagrams of lithium nickel manganese phosphates consistent with embodiments 1, 2, 3, and 4 of the present disclosure. FIG. 3 presents laser particle size distribution diagrams of lithium nickel manganese phosphates consistent with embodiments 1, 2, 3, and 4 of the present disclosure.

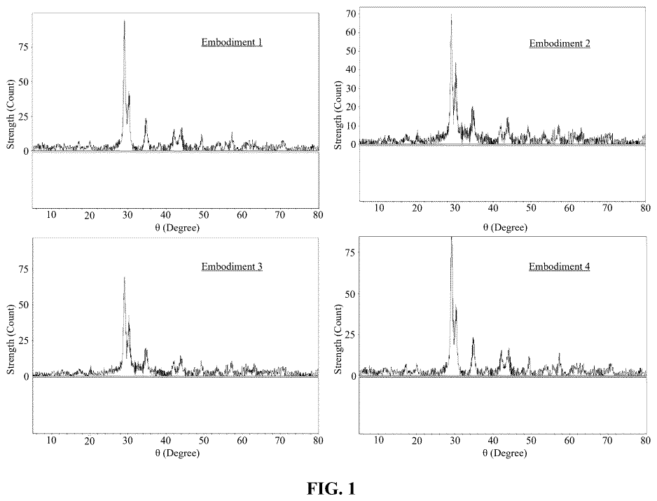

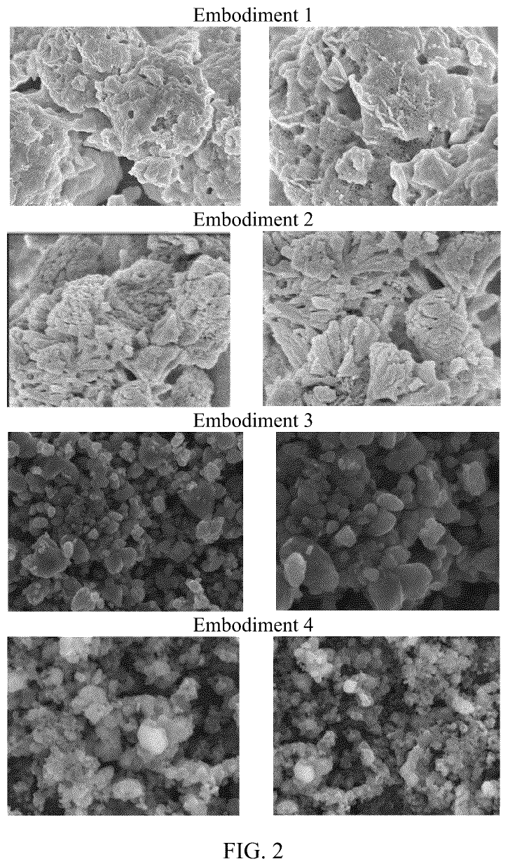

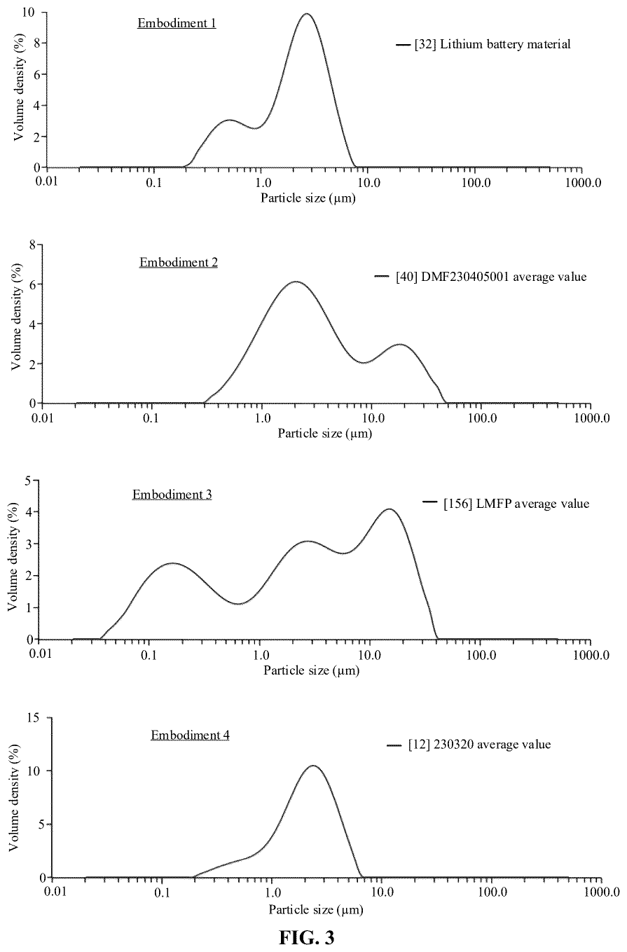

The carbon content of the carbon-coated nickel-manganese phosphate lithium anode material mentioned in the invention patent ranges from 0.1 to 5%;

### DETAILED DESCRIPTION OF THE EMBODIMENTS

Embodiments of the present disclosure are implemented by setting manganese, nickel source, lithium source, carbon source, and phosphorus source according to different process routes such as a solid-phase method, a liquid-phase method, or a hydrothermal method, and a nickel-manganese molar ratio to synthesize an LNMP or NMP product. A general molecular formula for the cathode material can be LiₐNi_{b}Mn_{d}MₑPO₄/C, and the valence of manganese is divalent.

A precursor can be nickel-manganese phosphate (NMIP) with a general structural formula of Ni_{b}Mn_{d}MₑPO₄. The valence of the nickel element and the manganese element can be divalent or trivalent. During synthesis, conductive additives such as carbon nanotubes (CNT) or graphene oxide (GO) can be added to improve the material properties and optimize certain electrical performance of the precursor.

A general structural formula of an olivine-structured nickel-manganese phosphate active material can be Ni_{b}Mn_{d}MₑPO₄, where b ranges from 0.1 to 0.95, d ranges from 0.05 to 0.95, and e is greater than or equal to 0 and less than or equal to 1.0. M represents a doping element selected from one or a combination of Fe, Al, Co, Ca, Pb, Na, Ti, Zr, Mo, V, Nb, Ni, Sc, Cr, Cu, Zn, Be, La, Mg, N, or S. The valences of the nickel element and the manganese element can be divalent or trivalent.

In some embodiments, in the general structural formula Ni_{b}Mn_{d}MₑPO₄, b can range from 0.5 to 0.95, d can range from 0.2 to 0.9, and e can range from 0.05 to 0.5.

In some embodiments, in the general structural formula Ni_{b}Mn_{d}MₑPO₄, b can range from 0.5 to 0.8, d can range from 0.2 to 0.5, and e can range from 0.05 to 0.15.

In some embodiments, in the general structural formula Ni_{b}Mn_{d}MₑPO₄, b can be 0.5, 0.6, 0.7, or 0.8, d can be 0.2, 0.3, 0.4, or 0.5, and e can be 0, 0.05, 0.1, or 0.15.

In some embodiments, in the general structural formula Ni_{b}Mn_{d}MₑPO₄, b can be 0.8, d can be 0.2, and e can be 0.05, 0.1, or 0.15. In some other embodiments, b can be 0.7, d can be 0.3, and e can be 0.05, 0.1, or 0.15. In some other embodiments, b can be 0.6, d can be 0.4, and e can be 0.05, 0.1, or 0.15. In still some other embodiments, b can be 0.5, d can be 0.5, and e can be 0.05, 0.1, or 0.15.

In some embodiments, the nickel-manganese phosphate active material prepared in the present disclosure can include the following structural formulas, such as Ni_{0.8}Mn_{0.2}PO₄, Ni_{0.8}Mn_{0.2}M_{0.05}PO₄, Ni_{0.8}Mn_{0.2}M_{0.1}PO₄, Ni_{0.8}Mn_{0.2}M_{0.15}PO₄, Ni_{0.7}Mn_{0.3}PO₄, Ni_{0.7}Mn_{0.3}M_{0.05}PO₄, Ni_{0.7}Mn_{0.3}M_{0.1}PO₄, Ni_{0.7}Mn_{0.3}M_{0.15}PO₄, Ni_{0.6}Mn_{0.4}PO₄, Ni_{0.6}Mn_{0.4}M_{0.05}PO₄, Ni_{0.6}Mn_{0.4}M_{0.1}PO₄, Ni_{0.6}Mn_{0.4}M_{0.15}PO₄, Ni_{0.5}Mn_{0.5}PO₄, Ni_{0.5}Mn_{0.5}M_{0.05}PO₄, Ni_{0.5}Mn_{0.5}M_{0.1}PO₄, Ni_{0.5}Mn_{0.5}M_{0.15}PO₄. M can be any one of Fe, Co, Ca, Pb, Na, Ti, Zr, Mo, V, Nb, Sc, Cr, Cu, Zn, Be, La, or Mg.

The manganese source used in the synthesis process in the above material can include one or a combination of elemental manganese, manganese monoxide, manganese dioxide, manganese nickel oxide, manganese tetroxide, manganese carbonate, manganese citrate, manganese acetate, manganese oxalate, manganese sulfate, manganese nitrate, or manganese chloride.

The nickel source can include one or a combination of elemental nickel, nickel hydroxide, nickel sulfate, nickel oxalate, nickel carbonate, nickel nitrate, or nickel chloride.

The source of the doping element M can include one or a combination of sulfates, phosphates, nitrates, chlorides, oxalates, acetates, carbonates of any one of Fe, Co, Ca, Pb, Na, Ti, Zr, Mo, V, Nb, Sc, Cr, Cu, Zn, Be, La, or Mg.

The olivine-structured nickel-manganese phosphate active material can have a particle size D₅₀ ranging from 0.5 to 2.0 μm. In some embodiments, the D₅₀ value can range from 1.0 to 1.6 μm. In some other embodiments, the D₅₀ can range from 1.2 to 1.55 μm.

For the above technical solution, the present disclosure further provides a carbon-coated lithium nickel-manganese phosphate composite material. The structural formula of the carbon-coated lithium nickel-manganese phosphate composite material can include the structural formula of the nickel-manganese phosphate active material. The structural formula of the carbon-coated lithium nickel-manganese phosphate composite material can be LiₐNi_{b}Mn_{d}MₑPO₄/C, a can range from 0.01 to 1.05, and a ratio between a sum of (a+b+d+e) and molar value of PO₄³⁻ can range from 0.90 to 1.05. Values of b, d, and e can be from the general formula Ni_{b}Mn_{d}MₑPO₄.

In some embodiments, a can range from 1.025 to 1.035. In some other embodiments, a can be any one of 1.025, 1.026, 1.027, 1.028, 1.029, 1.030, 1.031, 1.032, 1.033, 1.034, or 1.035. When a is greater than 0 and less than 1.025, pre-lithiated nickel manganese phosphate can be obtained.

A carbon source of the carbon-coated composite material can include one or a combination of organic carbon, artificial or natural graphite, graphene, carbon nanotubes or Super P, acetylene black, or another conductive carbon. The carbon content can range from 0.1 to 10%. The carbon introduced in the present disclosure can improve the conductivity, which is not the only manner. Low carbon content can be applied by being combined with another conductive agent. With a high carbon content, the processing performance can become poor, moisture can be difficult to control, and gram capacity can be relatively low.

The present disclosure further provides a 5V high-voltage platform phosphate cathode material. The material can include any one of the olivine-structured nickel manganese phosphate active material or the carbon-coated nickel manganese phosphate lithium composite material or a combination thereof.

In another technical solution of the present disclosure, the manganese, nickel source, lithium source, carbon source, and phosphorus source can be set according to different process routes such as a solid-phase method, a liquid-phase method, or a hydrothermal method, and a nickel-manganese molar ratio to synthesize an LNMP or NMP product. A general molecular formula for the cathode material can be LiₐNi_{b}Mn_{d}MₑPO₄/C, and the valence of manganese is divalent.

In some embodiments, a preparation method of the olivine-structured nickel manganese active material can include proportionally adding the manganese source, the nickel source, the phosphorus source, and the doping element raw material according to the elemental stoichiometric ratio in the above structural formula to obtain a mixture, thoroughly grinding and dispersing the mixture in a sand mill until the required particle size is reached, performing spraying and drying, performing sintering for dehydration and phase change by placing the dried material in the high-temperature sintering furnace to obtain the nickel manganese phosphate material.

In some other embodiments, the preparation method for the olivine-structured nickel manganese active material can include proportionally adding the manganese source, the nickel source, the lithium source, the carbon source, the phosphorus source, and the doping element raw material according to the elemental stoichiometric ratio in the above structural formula to obtain a mixture, thoroughly grinding and dispersing the mixture in the sand mill until the required particle size is reached, performing spraying and drying, performing sintering for dehydration and phase change by placing the dried material in the high-temperature sintering furnace to obtain the carbon-coated nickel manganese phosphate lithium cathode material.

The manganese source can include one or a combination of elemental manganese, manganese monoxide, manganese dioxide, trimanganese tetraoxide, manganese carbonate, manganese citrate, manganese acetate, manganese oxalate, manganese sulfate, manganese nitrate, and manganese chloride.

The nickel source can include one or a combination of elemental nickel, nickel hydroxide, nickel sulfate, nickel oxalate, nickel carbonate, nickel nitrate, and nickel chloride.

The lithium source can include one or a combination of lithium carbonate, lithium bicarbonate, lithium sulfate, lithium phosphate, lithium oxalate, and lithium hydroxide.

The phosphorus source can include one or a combination of ammonium phosphate, lithium phosphate, sodium phosphate, phosphoric acid, and metaphosphoric acid.

The source of the doping element M can include one or a combination of sulfates, phosphates, nitrates, chlorides, oxalates, acetates, and carbonates of Fe, Co, Ca, Pb, Na, Ti, Zr, Mo, V, Nb, Sc, Cr, Cu, Zn, Be, La, or Mg.

The carbon source can include one or a combination of organic carbon, synthesized or natural graphite, graphene, carbon nanotubes or Super P, acetylene black, or another conductive carbon.

In the above steps, after mixing the manganese source, nickel source, phosphorus source, and the doping element raw material, or mixing the manganese source, nickel source, lithium source, carbon source, phosphorus source, and doping element raw material, water can be added to adjust to a slurry, and a surfactant can be added. The mixture can be heated to 90-120° C. to react for 2 to 4 hours. After the reaction, the resulting lithium nickel manganese phosphate filter cake can be obtained after filtration. The filter cake can be dried and then ball-milled.

The surfactant can be a mixture of Allyl polypropylene glycol, Polyvinylpyridine, and Polyvinylpyrrolidone (PVP) with a mass ratio of 4:(2 to 3):(0.5 to 2).

During a ball milling process, the carbon source and lithium source can be added to cause the molar amount of lithium to range from 0.01 to 1.05 and the carbon content to range from 0.1 to 10% in the obtained product structural formula of LiₐNi_{b}Mn_{d}MₑPO₄/C.

In the process of preparing the nickel manganese phosphate material, the doping element M can be selectively added. According to the atomic ratio of the raw materials of the manganese source, nickel source, phosphorus source, and doping element M, the added amount of the raw materials can be controlled to cause the general structural formula of the nickel manganese phosphate active material to be Ni_{b}Mn_{d}MₑPO₄. b can range from 0.1 to 0.95, d can range from 0.05 to 0.9, and e can be greater than or equal to 0 and less than or equal to 0.5. M represents the doping elements. M can be selected from one or a combination of Fe, Al, Co, Ca, Pb, Na, Ti, Zr, Mo, V, Nb, Sc, Cr, Cu, Zn, Be, La, Mg, N, or S, or Al.

In some embodiments, a structural formula of the nickel manganese phosphate active material prepared can be Ni_{0.8}Mn_{0.2}PO₄, Ni_{0.7}Mn_{0.3}PO₄, Ni_{0.6}Mn_{0.4}PO₄, or Ni_{0.5}Mn_{0.5}PO₄. M can include any one of Fe, Co, Ca, Pb, Na, Ti, Zr, Mo, V, Nb, Sc, Cr, Cu, Zn, Be, La, or Mg.

The particle size requirement for the single-component material is D₅₀, which is within 400 nm, in some embodiments 200 nm, or in some other embodiments, 100 nm. The nanoscale material have good gram capacity and rate characteristics, and the cycling performance is better.

The sand milling particle size can be controlled at D₅₀, which ranges from 0.2 to 0.8 μm.

The particle size of the product obtained after spraying and drying can range from 15 to 25 μm. In some embodiments, the particle size can range from 10 to 15 μm.

The carbon-coating sintering temperature can include that a temperature for a low-temperature coke discharge stage can be set at 250 to 650° C., in some embodiments, 400 to 500° C., and a temperature for a high-temperature phase change stage can be set at 680 to 800° C., in some embodiments, 700 to 790° C.

An olivine-structured nickel manganese active material can be prepared using one of the above methods to obtain a nickel manganese phosphate cathode material or a carbon-coated nickel manganese phosphate cathode material. The active material as a phosphate cathode material can have a 5V high-voltage platform.

A 5V high-voltage platform phosphate cathode material can be prepared using one of the above methods to obtain the nickel manganese phosphate cathode material or the carbon-coated nickel manganese phosphate cathode material. The structural formula of the nickel manganese phosphate cathode material can be Ni_{b}Mn_{d}MₑPO₄, where b can range from 0.1 to 0.95, d can range from 0.05 to 0.9, and e can be greater than or equal to 0 and less than or equal to 0.5. M represents the doping element selected from one or a combination of Fe, Al, Co, Ca, Pb, Na, Ti, Zr, Mo, V, Nb, Sc, Cr, Cu, Zn, Be, La, Mg, N, S, or Al

In some embodiments, in the general structural formula Ni_{b}Mn_{d}MₑPO₄, b can range from 0.5 to 0.95, d can range from 0.2 to 0.9, and e can range from 0.05 to 0.5.

In some other embodiments, in the general structural formula Ni_{b}Mn_{d}MₑPO₄, b can range from 0.5 to 0.8, d can range from 0.2 to 0.5, and e can range from 0 to 0.15.

In some other embodiments, in the general structural formula Ni_{b}Mn_{d}MₑPO₄, b can be 0.5, 0.6, 0.7, or 0.8, d can be 0.2, 0.3, 0.4, or 0.5, and e can be 0, 0.05, 0.1, or 0.15.

In some other embodiments, in the general structural formula Ni_{b}Mn_{d}MₑPO₄, b can be 0.8, d can be 0.2, and e can be 0.05, 0.1, or 0.15. In some other embodiments, b can be 0.7, d can be 0.3, and e can be 0.05, 0.1, or 0.15. In some other embodiments, b can be 0.6, d can be 0.4, and e can be 0.05, 0.1, or 0.15. In some other embodiments, b can be 0.5, d can be 0.5, and e can be 0, 0.05, 0.1, or 0.15.

In some embodiments, the structural formula of the nickel manganese phosphate active material can include Ni_{0.8}Mn_{0.2}M_{0.05}PO₄, Ni_{0.8}Mn_{0.2}M_{0.1}PO₄, Ni_{0.8}Mn_{0.2}M_{0.15}PO₄, Ni_{0.7}Mn_{0.3}M_{0.05}PO₄, Ni_{0.7}Mn_{0.3}M_{0.1}PO₄, Ni_{0.7}Mn_{0.3}M_{0.15}PO₄, Ni_{0.6}Mn_{0.4}M_{0.05}PO₄, Ni_{0.6}Mn_{0.4}M_{0.1}PO₄, Ni_{0.6}Mn_{0.4}M_{0.15}PO₄, Ni_{0.5}Mn_{0.5}M_{0.05}PO₄, Ni_{0.5}Mn_{0.5}M_{0.1}PO₄, or Ni_{0.5}Mn_{0.5}M_{0.15}PO₄. M can include any one of Fe, Co, Ca, Pb, Na, Ti, Zr, Mo, V, Nb, Sc, Cr, Cu, Zn, Be, La, or Mg.

The carbon-coated lithium nickel manganese phosphate cathode material obtained using one of the methods can have a structural formula of LiₐNi_{b}Mn_{d}MₑPO₄/C, where a can range from 0.01 to 1.05, and a ratio of a sum of (a+b+d+e) and a moler value of PO₄³⁻ can range from 0.90 to 1.05.

In some embodiments, a can range from 1.025 to 1.035. In some other embodiments, a can include any one of 1.025, 1.026, 1.027, 1.028, 1.029, 1.030, 1.031, 1.032, 1.033, 1.034, or 1.035.

When 0<a<1.025, pre-lithiated nickel manganese phosphate can be obtained.

A method for preparing an olivine-structured nickel manganese phosphate active material can include sufficiently dissolving and filtering the manganese source and the nickel source in a phosphorus source solution of a certain concentration, adding an alkaline substance to adjust the pH value to range from 2 to 9 for precipitation and crystallization, filtering the slurry after crystallization to obtain a filter cake, and performing drying and sintering on the filter cake to obtain the olivine-structured nickel manganese phosphate active material.

In some embodiments, the method can include adding the carbon source, the lithium source, and the doping element to the nickel manganese phosphate active material, performing grinding and dispersing on the nickel manganese phosphate active material added with the carbon source, the lithium source, and the doping element, performing spraying and drying on the particles after grinding and dispersing, and performing the sintering on the dried particles to obtain the olivine-structured carbon-coated nickel manganese phosphate lithium cathode material.

In the preparation of the nickel manganese phosphate active material, the adding amounts of the various raw materials can be adjusted appropriately according to the structural formula Ni_{b}Mn_{d}MₑPO₄, where b can range from 0.1 to 0.95, d can range from 0.05 to 0.9, and e can be greater than and equal to 0 and less than or equal to 0.5. In other some embodiments, the adding amounts of the various raw materials can be adjusted appropriately according to the structural formula LiₐNi_{b}Mn_{d}MₑPO₄/C, where a can range from 0.01 to 1.05, and the ratio between the sum of (a+b+d+e) and the molar value of PO₄³⁻ can range from 0.90 to 1.05.

The alkaline substance can include sodium hydroxide, lithium hydroxide, ammonia water, cesium carbonate, sodium carbonate, sodium bicarbonate, sodium methoxide, potassium ethoxide, or potassium tert-butoxide.

The pH value can be adjusted to range from 1 to 5 by adding the alkaline substance. In some embodiments, the pH value can be adjusted to range from 1.5 to 5. In some other embodiments, the pH value can be adjusted to range from 3.5 to 4.5.

Under this environment, the elements of the crystallization of the material can effectively form a crystal, which prevents necessary elements in the material from being still in an ionic state. Meanwhile, a substance can have a purer crystal phase and higher crystallinity.

Time for the precipitation and crystallization can range from 1 to 48 hours. In some embodiments, the time for the precipitation and crystallization can range from 12 to 16 hours. In some other embodiments, the time for the precipitation and crystallization can range from 8 to 10 hours. In some other embodiments, the time for the precipitation and crystallization can range from 4 to 6 hours.

The manganese source can include one or a combination of elemental manganese, manganese monoxide, manganese dioxide, trimanganese tetraoxide, manganese carbonate, manganese citrate, manganese acetate, manganese oxalate, manganese sulfate, manganese nitrate, or manganese chloride.

The nickel source can include one or a combination of elemental nickel, nickel hydroxide, nickel sulfate, nickel oxalate, nickel carbonate, nickel nitrate, or nickel chloride.

The lithium source can include one or a combination of lithium carbonate, lithium bicarbonate, lithium sulfate, lithium phosphate, lithium oxalate, or lithium hydroxide.

The phosphorus source can include one or a combination of ammonium phosphate, lithium phosphate, sodium phosphate, phosphoric acid, or pyrophosphoric acid.

The raw material for the doping element M can include one or a combination of sulfates, phosphates, nitrates, chlorides, oxalates, or acetates of Fe, Co, Ca, Pb, Na, Ti, Zr, Mo, V, Nb, Sc, Cr, Cu, Zn, Be, La, or Mg.

The carbon source can include one or a combination of organic carbon, synthetic or natural graphite, graphene, carbon nanotubes or Super P, acetylene black, or another conductive carbon.

The grinding particle size D₅₀ can be controlled to range from 0.2˜0.8 μm.

The particle size of the product obtained after the spraying and drying can range from 15 to 25 μm, In some embodiments, the particle size can range from 10 to 15 μm.

The carbon-coating sintering temperature can include that a temperature for a low-temperature coke discharge stage can be set at 250 to 650° C., in some embodiments, 400 to 500° C., and a temperature for a high-temperature phase change stage can be set at 680 to 800° C., in some embodiments, 700 to 790° C.

An olivine-structured nickel manganese phosphate active material can be prepared using the above method to obtain the nickel manganese phosphate cathode material or carbon-coated nickel-manganese phosphate cathode material. The active material as the phosphate cathode material can have the 5V high-voltage platform.

A 5V high-voltage platform phosphate cathode material can be prepared using the above method to obtain the nickel manganese phosphate cathode material or the carbon-coated nickel manganese phosphate cathode material. The structural formula of the nickel manganese phosphate cathode material can be Ni_{b}Mn_{d}MₑPO₄, where b can range from 0.1 to 0.95, d can range from 0.05 to 0.9, and e can be greater than or equal to 0 and less than or equal to 0.5. M represents the doping element selected from one or a combination of Fe, Al, Co, Ca, Pb, Na, Ti, Zr, Mo, V, Nb, Sc, Cr, Cu, Zn, Be, La, Mg, N, or S.

In some embodiments, in the general structural formula Ni_{b}Mn_{d}MₑPO₄, b can range from 0.5 to 0.95, d can range from 0.2 to 0.9, and e can range from 0.05 to 0.5.

In some other embodiments, in the general structural formula Ni_{b}Mn_{d}MₑPO₄, b can range from 0.5 to 0.8, d can range from 0.2 to 0.5, and e can range from 0 to 0.15.

In some other embodiments, in the general structural formula Ni_{b}Mn_{d}MₑPO₄, b can be 0.5, 0.6, 0.7, or 0.8, d can be 0.2, 0.3, 0.4, or 0.5, and e can be 0, 0.05, 0.1, or 0.15.

In some other embodiments, in the general structural formula Ni_{b}Mn_{d}MₑPO₄, b can be 0.8, d can be 0.2, and e can be 0.05, 0.1, or 0.15. In some other embodiments, b can be 0.7, d can be 0.3, and e can be 0.05, 0.1, or 0.15. In some other embodiments, b can be 0.6, d can be 0.4, and e can be 0.05, 0.1, or 0.15. In some other embodiments, b can be 0.5, d can be 0.5, and e can be 0, 0.05, 0.1, or 0.15.

In some embodiments, the structural formula of the nickel manganese phosphate active material can include Ni_{0.8}Mn_{0.2}M_{0.05}PO₄, Ni_{0.8}Mn_{0.2}M_{0.1}PO₄, Ni_{0.8}Mn_{0.2}M_{0.15}PO₄, Ni_{0.7}Mn_{0.3}M_{0.05}PO₄, Ni_{0.7}Mn_{0.3}M_{0.1}PO₄, Ni_{0.7}Mn_{0.3}M_{0.15}PO₄, Ni_{0.6}Mn_{0.4}M_{0.05}PO₄, Ni_{0.6}Mn_{0.4}M_{0.1}PO₄, Ni_{0.6}Mn_{0.4}M_{0.15}PO₄, Ni_{0.5}Mn_{0.5}M_{0.05}PO₄, Ni_{0.5}Mn_{0.5}M_{0.1}PO₄, or Ni_{0.5}Mn_{0.5}M_{0.15}PO₄. M can include any one of Fe, Co, Ca, Pb, Na, Ti, Zr, Mo, V, Nb, Sc, Cr, Cu, Zn, Be, La, or Mg.

The carbon-coated lithium nickel manganese phosphate cathode material obtained using the above method can have the structural formula of LiₐNi_{b}Mn_{d}MₑPO₄/C, where a can range from 0.01 to 1.05, and the ratio between the sum of (a+b+d+e) and the molar value of PO₄³⁻ can range from 0.90 to 1.05.

In some embodiments, a can range from 1.0 to 1.05. In some other embodiments, a can include any one of 1.025, 1.026, 1.027, 1.028, 1.029, 1.030, 1.031, 1.032, 1.033, 1.034, or 1.035.

When 0<a<1.025, pre-lithiated nickel manganese phosphate can be obtained.

The present disclosure provides a preparation method for an olivine-structured nickel manganese phosphate active material. The method can include sufficiently dissolving and filtering the soluble manganese source, nickel source, and phosphorus source according to the stoichiometric ratio to obtain a clean solution, performing a hydrothermal reaction under certain pressure and temperature in a hydrothermal reactor, discharging and filtering after a period of hydrothermal reaction to obtain a filter cake, and performing drying and sintering on the filter cake to obtain the olivine-structured nickel manganese phosphate active material.

In some other embodiments, the method can include sufficiently dissolving and filtering the soluble manganese source, nickel source, lithium source, phosphorus source, carbon source, and doping element according to the stoichiometric ratio to obtain a clean solution, performing a hydrothermal reaction under certain pressure and temperature in a hydrothermal reactor, discharging and filtering after a period of hydrothermal reaction to obtain a filter cake, and performing drying and sintering on the filter cake to obtain the olivine-structured nickel manganese phosphate active material.

The stoichiometric ratio can refer to that the adding amounts of the sources can be appropriately adjusted according to the structural formula Ni_{b}Mn_{d}MₑPO₄, where b can range from 0.1 to 0.95, d can range from 0.05 to 0.9, and e can be greater than or equal to 0 and less than or equal to 0.5. In some other embodiments, the adding amounts of the sources can be appropriately adjusted according to the structural formula LiₐNi_{b}Mn_{d}MₑPO₄/C, where a can range from 0.01 to 1.05, and the ratio between the sum of (a+b+d+e) and the mole ratio of PO₄³⁻ can be adjusted to be from 0.90 to 1.05.

A temperature of the hydrothermal reaction can range from 120 to 200° C., and a pressure of the hydrothermal reaction can range from 0.1 to 20 MPa. A sintering temperature can range from 200 to 800° C. In some embodiments, the sintering temperature can range from 450 to 500° C.

The manganese source can include one or a combination of elemental manganese, manganese monoxide, manganese dioxide, Trimanganese tetroxide, manganese carbonate, manganese citrate, manganese acetate, manganese oxalate, manganese sulfate, manganese nitrate, or manganese chloride.

The nickel source can include one or a combination of elemental nickel, nickel hydroxide, nickel sulfate, nickel oxalate, nickel carbonate, nickel nitrate, or nickel chloride.

The lithium source can include one or a combination of lithium carbonate, lithium bicarbonate, lithium sulfate, lithium phosphate, lithium oxalate, or lithium hydroxide.

The phosphorus source can include one or a combination of ammonium phosphate, lithium phosphate, sodium phosphate, phosphoric acid, or metaphosphoric acid.

The raw material for the doping element M can include one or a combination of sulfate, phosphate, nitrate, chloride, oxalate, or acetate of Fe, Co, Ca, Pb, Na, Ti, Zr, Mo, V, Nb, Sc, Cr, Cu, Zn, Be, La, or Mg.

The carbon source can include one or a combination of organic carbon, synthetic or natural graphite, graphene, carbon nanotubes or Super P, acetylene black, or another conductive carbon.

An olivine-structured nickel manganese phosphate active material can be prepared using the above method to obtain the nickel manganese phosphate cathode material or carbon-coated nickel-manganese phosphate cathode material. The active material as the phosphate cathode material can have the 5V high-voltage platform.

A 5V high-voltage platform phosphate cathode material can be prepared using the above method to obtain the nickel manganese phosphate cathode material or the carbon-coated nickel manganese phosphate cathode material. The structural formula of the nickel manganese phosphate cathode material can be Ni_{b}Mn_{d}MₑPO₄, where b can range from 0.1 to 0.95, d can range from 0.05 to 0.9, and e can be greater than or equal to 0 and less than or equal to 0.5. M represents the doping element selected from one or a combination of Fe, Co, Ca, Pb, Na, Ti, Zr, Mo, V, Nb, Sc, Cr, Cu, Zn, Be, La, Mg, N, S, or Al.

In some embodiments, in the general structural formula Ni_{b}Mn_{d}MₑPO₄, b can range from 0.5 to 0.95, d can range from 0.2 to 0.9, and e can range from 0.05 to 0.5.

In some other embodiments, in the general structural formula Ni_{b}Mn_{d}MₑPO₄, b can range from 0.5 to 0.8, d can range from 0.2 to 0.5, and e can range from 0 to 0.15.

In some other embodiments, in the general structural formula Ni_{b}Mn_{d}MₑPO₄, b can be 0.5, 0.6, 0.7, or 0.8, d can be 0.2, 0.3, 0.4, or 0.5, and e can be 0, 0.05, 0.1, or 0.15.

In some other embodiments, in the general structural formula Ni_{b}Mn_{d}MₑPO₄, b can be 0.8, d can be 0.2, and e can be 0.05, 0.1, or 0.15. In some other embodiments, b can be 0.7, d can be 0.3, and e can be 0.05, 0.1, or 0.15. In some other embodiments, b can be 0.6, d can be 0.4, and e can be 0.05, 0.1, or 0.15. In some other embodiments, b can be 0.5, d can be 0.5, and e can be 0, 0.05, 0.1, or 0.15.

In some embodiments, the structural formula of the nickel manganese phosphate active material can include Ni_{0.8}Mn_{0.2}M_{0.05}PO₄, Ni_{0.8}Mn_{0.2}M_{0.1}PO₄, Ni_{0.8}Mn_{0.2}M_{0.15}PO₄, Ni_{0.7}Mn_{0.3}M_{0.05}PO₄, Ni_{0.7}Mn_{0.3}M_{0.1}PO₄, Ni_{0.7}Mn_{0.3}M_{0.15}PO₄, Ni_{0.6}Mn_{0.4}M_{0.05}PO₄, Ni_{0.6}Mn_{0.4}M_{0.1}PO₄, Ni_{0.6}Mn_{0.4}M_{0.15}PO₄, Ni_{0.5}Mn_{0.5}M_{0.05}PO₄, Ni_{0.5}Mn_{0.5}M_{0.1}PO₄, or Ni_{0.5}Mn_{0.5}M_{0.15}PO₄. M can include any one of Fe, Co, Ca, Pb, Na, Ti, Zr, Mo, V, Nb, Sc, Cr, Cu, Zn, Be, La, or Mg.

The carbon-coated lithium nickel manganese phosphate cathode material obtained using the above method can have the structural formula of LiₐNi_{b}Mn_{d}MₑPO₄/C, where a can range from 0.01 to 1.05, and the ratio between the sum of (a+b+d+e) and the molar value of PO₄³⁻ can range from 0.90 to 1.05.

In some embodiments, a can range from 1.025 to 1.035. In some other embodiments, a can include any one of 1.025, 1.026, 1.027, 1.028, 1.029, 1.030, 1.031, 1.032, 1.033, 1.034, or 1.035.

When 0<a<1.025, pre-lithiated nickel manganese phosphate can be obtained.

The present disclosure provides a 5V high-voltage lithium battery electrode, which includes a battery electrode made of the cathode material, i.e., the carbon-coated nickel-manganese-lithium phosphate composite cathode material electrode. The cathode material can include 1-100 wt % of the carbon-coated nickel-manganese-lithium phosphate cathode material. The structural formula of the carbon-coated nickel-manganese-lithium phosphate cathode material can be LiₐNi_{b}Mn_{d}MₑPO₄/C, where a can range from 0.01 to 1.05, and the ratio between the sum of (a+b+d+e) and the mole ratio of PO₄³⁻ can range from 0.90 to 1.05.

In some embodiments, a can range from 1.025 to 1.035. In some other embodiments, a can include any one of 1.025, 1.026, 1.027, 1.028, 1.029, 1.030, 1.031, 1.032, 1.033, 1.034, or 1.035.

When 0<a<1.025, pre-lithiated nickel manganese phosphate can be obtained.

The cathode material can include 1 to 90 wt % of the carbon-coated nickel-manganese-lithium phosphate cathode material. In some embodiments, the cathode material can include 10 to 80 wt % of the carbon-coated nickel-manganese-lithium phosphate cathode material. In some other embodiments, the cathode material can include 20 to 70 wt % of the carbon-coated nickel-manganese-lithium phosphate cathode material. In some other embodiments, the cathode material can include 30 to 60 wt % of the carbon-coated nickel-manganese-lithium phosphate cathode material.

When the carbon-coated of the carbon-coated nickel-manganese-lithium phosphate cathode material is less than 100%, the cathode material can further include another cathode material. Another cathode material can include any one of lithium cobalt oxide, lithium manganese oxide, nickel-cobalt-aluminum ternary polymer material, nickel-cobalt-manganese ternary polymer material, and nickel-manganese phosphate active material with an olivine structure.

In some embodiments, the present disclosure provides a 5V high-voltage lithium battery. The lithium battery can include lithium batteries with different specifications having the 5V high voltage lithium battery electrode, which is made into a corresponding stack, a square aluminum shell, a cylindrical winding, or another shaped structure. The lithium battery can include at least an electrolyte solution having lithium elements.

The manganese source of the present disclosure can include elemental manganese, manganese monoxide, manganese dioxide, manganese tetroxide, manganese carbonate, manganese citrate, manganese acetate, manganese oxalate, manganese sulfate, manganese nitrate, and manganese chloride, which are materials at or above the grade of analytical reagent (AR).

The nickel source can include elemental nickel, nickel hydroxide, nickel sulfate, nickel oxalate, nickel carbonate, nickel nitrate, and nickel chloride, which are materials at or above the grade of AR.

The lithium source can include lithium carbonate, lithium hydroxide, lithium sulfate, lithium phosphate, lithium oxalate, and lithium acetate, which are materials at or above the grade of AR.

The phosphorus source can include phosphorus pentoxide, phosphoric acid, and hypophosphorous acid, which are materials at or above the grade of AR.

The raw material for the doping element M can include sulfate, phosphate, nitrate, chloride, oxalate, acetate, and carbonate salts of Fe, Co, Ca, Pb, Na, Ti, Zr, Mo, V, Nb, Sc, Cr, Cu, Zn, Be, La, or Mg, which are materials at or above the grade of AR.

The carbon source can include organic carbon, synthetic or natural graphite, graphene, carbon nanotubes or Super P, acetylene black, or another conductive carbon, which are materials at or above the grade of AR.

A surface active agent of the present disclosure can be a mixture formed by Allyl polyethylene glycol, Polyvinylpyridine, and Polyvinylpyrrolidone (PVP).

In embodiment one, the method can include the following steps.
1. 2000 g of a 16% dilute phosphoric acid solution with a Baumé degree of 10.5-11°Bé is weighed. 178.5 g of analytical reagent nickel hydroxide, 0.5 g of battery-grade titanium dioxide, 64 g of battery-grade trimanganese tetraoxide, 57.9 g of lithium carbonate, and 15 g of a 5% graphene oxide slurry are sequentially added into a reactor and stirred sufficiently for 10 minutes. Then, 15 g of a high-efficiency surface active agent (a mixture of Allyl polypropylene glycol, Polyvinylpyridine, and PVP in a mass ratio of 4:3:2) is added. The temperature is increased to approximately 90° C., stirring is performed to allow a sufficient reaction for 2-4 hours.
2. The solution obtained in the previous step is filtered through a plate and frame filter to obtain a filter cake of nickel-manganese lithium phosphate as a wet product for later use.
3. The wet product is dried in a CT hot air circulating oven at 140° C. for 2.5 hours. The obtained dry product is crushed and then sieved. Then, component analysis is performed. Based on component contents, the mass of the organic carbon source and the optimized and adjusted lithium amount through the chemical stoichiometry and the carbon content in LNMP. The additional amounts of glucose of the organic carbon source and PEG6000 are 20.33 g and 12.4 g, respectively. The additional amount of lithium carbonate is 1.59 g.
4. The solid-to-liquid ratio of the above material is controlled at 40-45%, and the viscosity of the above material is controlled at 4000-5000 Pa·S. The material is stirred sufficiently in a mixing tank for 10 minutes and then is pumped into a sand mill for grinding. The particle size D₅₀ is controlled to be equal to 500 nm, and the rotation speed of the main engine can be set at 1200 r/min.
5. Spraying and drying are performed on the sand-milled slurry.
6. The material from step 5 is sintered in an N₂ inert furnace. The temperature of the low-temperature sintering is controlled at 450° C., and the temperature of the high-temperature sintering is controlled at 760° C. The temperature rising speed is controlled at 3° C./min.
7. The material of step 6 is crushed through the airflow, and the particle size D₅₀ is controlled at 1.27 μm. After sieving, grading, and packaging, 260.7 g of the finished product of carbon-coated nickel-manganese lithium phosphate (LNMP/C) is obtained, i.e., LiMn_{0.4}Ni_{0.6}PO₄/C (with a nickel-to-manganese molar ratio of 6:4). This material can be measured with a carbon content, compaction, and electrical performance. (Li in the material is expressed only as a mass percentage, typically ranging from 4.2% to 4.5%.)
8. The LNMP/C powder material from step 7, PVDF, and conductive carbon black are mixed in a mass ratio of 90:5:5. The mixture is dispersed and adjusted with a dispersing agent of N-methyl-2-pyrrolidone. To ensure uniform dispersion, strong dispersion is performed using a dual planetary mixer. The dispersed slurry is evenly coated onto a carbon-coated aluminum foil through a coating machine and then is dried.
9. The dried semi-finished electrode sheet obtained after drying is then extruded by a roller machine twice. The extruded electrode sheet is then cut into circular electrode sheets of φ18 mm using a punching machine, which are cathode sheets to facilitate assembly of button cell batteries.
10. The electrode sheets are assembled to form 2032 button cell batteries according to the requirements of simulated batteries button cell for electrical performance testing.

The obtained test results for the finished product are shown in the table below.

Embodiment one ICP Result

| | Measurement result |
|---|---|
| Element | (ppm) |
| Ca | 34.72 |
| Mg | 59.84 |
| Pb | 6.9 |
| Na | 19.23 |
| Cu | 2.89 |
| Cd | 3.49 |
| Zn | 3.45 |
| Ti | 1540 |

Chemical Titration Analysis (%)

| Ni | 21.72 | |
|---|---|---|
| Ma | 13.55 | |
| Ni:Ma (Molar ratio) | 6:4 | |
| C % | 1.54% | |
| Li | 4.28% | |
| Powder compaction | 2.46 | g/cm³ |
| (3T 15 min) | | |
| 0.1 C gram capacity | 159.88 | mAh/g |
| Median voltage | 5.18 | v |
| D₅₀ | 1.27 | μm |

In embodiment two, the method can include the following steps.
1. 300 g of battery-grade nickel sulfate and 300 g of industrial-grade phosphoric acid (85%) are dissolved in 2500 g of pure water at around 80° C. Then, 140.7 g of battery-grade manganese sulfate monohydrate, 90.2 g of battery-grade lithium hydroxide, 20 g of a 5% graphene oxide slurry are sequentially added into the reactor and stirred for 10 minutes. Then, 15 g of the high-efficiency surface active agent (a mixture of Allyl polypropylene glycol, Polyvinylpyridine, and PVP in a mass ratio of 4:3:2) is added. The temperature is increased to approximately 95° C., stirring is performed to allow sufficient reaction for 60 minutes. The pH value is adjusted to 3.5-4.5 using ammonia water, and then the temperature is continuously maintained to allow the reaction for 120 minutes.
2. The solution obtained through the plate and frame filter or a PP barrel-type precision filter to obtain a filter cake of nickel-manganese phosphate as a wet product for later use.
3. The wet NMP product is dried in the CT hot air circulating oven at 140° C. for 2.5 hours. The dry product is crushed and then sieved. The component analysis is performed. Based on the component contents, the mass of the organic carbon source and the optimized and adjusted lithium amount are calculated according to the chemical stoichiometry and the carbon content in LNMP. The additional amounts of glucose of the organic carbon source and PEG6000 are 23.5 g and 15.7 g, respectively. The additional amount of lithium carbonate is 2.37 g.
4. The solid-to-liquid ratio of the above material is controlled at 40-45%, and the viscosity of the material is controlled at 4000-5000 Pa S. The material is sufficiently stirred in the mixing tank for 15 minutes and pumped into the sand mill for grinding. The particle size D₅₀ is controlled to be equal to 400 nm. The rotation speed of the main engine is set to 900 r/min.
5. Spraying and drying are performed on the sand-milled slurry.
6. Sintering is performed on the above material in the inert furnace protected by the high-purity N₂. The temperature of the low-temperature sintering is controlled at 450° C. and the temperature of the high-temperature sintering is controlled at 730° C. The temperature rising speed is controlled at 3° C./min.
7. The material of step 6 is crushed through the airflow, and the particle size D₅₀ is controlled at 1.34 μm. After sieving, grading, and packaging, 410.9 g of finished product of carbon-coated nickel-manganese lithium phosphate (LNMP/C) is obtained, i.e., LiMn_{0.2}Ni_{0.8}PO₄/C (with a nickel-to-manganese molar ratio of 8:2). This material can be measured with a carbon content, compaction, and electrical performance.
8. The LNMP/C powder material from step 7, PVDF, and conductive carbon black are mixed in a mass ratio of 95:5:5. The mixture is then dispersed and adjusted with a dispersing agent of N-methyl-2-pyrrolidone. To ensure uniform dispersion, strong dispersion is performed using a dual planetary mixer. The dispersed slurry is evenly coated onto a carbon-coated aluminum foil through a coating machine and then is dried.
9. The dried semi-finished electrode sheet obtained after drying is then extruded by a roller machine twice. The extruded electrode sheet is then cut into circular electrode sheets of Φ 18 mm using a punching machine, which are cathode sheets to facilitate assembly of button cell batteries.
10. The electrode sheets are assembled to form 2032 button cell batteries according to the requirements of simulated batteries button cell for electrical performance testing.

The obtained test results for the finished product are shown in the table below.

Embodiment two ICP Result

| | Measurement result |
|---|---|
| Element | (ppm) |
| Ca | 65.99 |
| Mg | 41.34 |
| Pb | 10.2 |
| Na | 71.41 |
| Cu | 2.89 |
| Cd | 3.49 |
| Zn | 3.45 |

Chemical Titration Analysis (%)

| Ni | 28.79 | |
|---|---|---|
| Ma | 6.73 | |
| Ni:Ma (Molar ratio) | 8:2 | |
| C % | 1.81% | |
| Li | 4.25% | |
| Powder compaction | 2.35 | g/cm³ |
| (3T 15 min) | | |
| 0.1 C gram capacity | 157.63 | mAh/g |
| Median Voltage | 5.3 | v |
| D₅₀ | 1.34 | μm |

In embodiment three, the method can include the following steps.
1. 550 g of analytical-grade nickel nitrate and 332 g of industrial-grade phosphoric acid (85%) are weighed and dissolved in 2000 g of pure water at around 75° C. Then, 212.5 g of battery-grade manganese nitrate, 71.5 g of battery-grade lithium hydroxide, and 7 g of CNT are sequentially added into a 5000 L hydrothermal reactor. The temperature is set to 180±2° C., and the pressure in the reactor is maintained at 1.35±0.1 Mpa to allow sufficient reaction for 240 minutes.
2. The slurry obtained in the previous step through the plate and frame filter is filtered to obtain a filter cake of nickel-manganese lithium phosphate as a wet LNMP product for later use.
3. The wet LNMP product is dried in the CT hot air circulating oven at 160° C. for 2.5 hours. The dry product is crushed and then sieved. The component analysis is performed. Based on the component contents, the mass of the organic carbon source and the optimized and adjusted lithium amount are calculated according to the chemical stoichiometry and the carbon content in LNMP. The additional amounts of glucose of the organic carbon source and PEG6000 are 22.7 g and 12.5 g, respectively. The additional amount of lithium carbonate is 1.89 g.
4. The solid-to-liquid ratio of the above material is controlled at 40-45%, and the viscosity of the material is controlled at 4000-5000 Pa S. The material is sufficiently stirred in the mixing tank for 15 minutes and pumped into the sand mill for grinding. The particle size D₅₀ is controlled to be equal to 600 nm. The rotation speed of the main engine is set to 900 r/min.
5. Spraying and drying are performed on the sand-milled slurry.
6. Sintering is performed on the material obtained in step 5 in the inert furnace protected by the high-purity N₂. The temperature of the low-temperature sintering is controlled at 450° C. and the temperature of the high-temperature sintering is controlled at 770° C. The temperature rising speed is controlled at 3° C./min.
7. The material of step 6 is crushed through the airflow, and the particle size D₅₀ is controlled at 1.51 μm. After sieving, grading, and packaging, 410.9 g of finished product of carbon-coated nickel-manganese lithium phosphate (LNMP/C) is obtained, i.e., LiMn_{0.3}Ni_{0.7}PO₄/C (with a nickel-to-manganese molar ratio of 7:3). This material can be measured with a carbon content, compaction, and electrical performance.
8. The LNMP/C powder material from step 7, PVDF, and conductive carbon black are mixed in a mass ratio of 95:5:5. The mixture is then dispersed and adjusted with a dispersing agent of N-methyl-2-pyrrolidone. To ensure uniform dispersion, strong dispersion is performed using a dual planetary mixer. The dispersed slurry is evenly coated onto a carbon-coated aluminum foil through a coating machine and then is dried.
9. The dried semi-finished electrode sheet obtained after drying is then extruded by a roller machine twice. The extruded electrode sheet is then cut into circular electrode sheets of Φ 18 mm using a punching machine, which are cathode sheets to facilitate assembly of button cell batteries.
10. The electrode sheets are assembled to form 2032 button cell batteries according to the requirements of simulated batteries button cell for electrical performance testing.

The obtained test results for the finished product are shown in the table below.

Embodiment three ICP Result

| | Measurement result |
|---|---|
| Element | (ppm) |
| Ca | 10.74 |
| Mg | 23.87 |
| Pb | 15.53 |
| Na | 51.69 |
| Cu | 1.24 |
| Cd | 3.89 |
| Zn | 10.65 |

Chemical Titration Analysis (%)

| Ni | 25.31 | |
|---|---|---|
| Ma | 10.10 | |
| Ni:Ma (Molar ratio) | 7:3 | |
| C % | 1.46% | |
| Li | 4.27% | |
| Powder compaction | 2.27 | g/cm³ |
| (3T 15 min) | | |
| 0.1 C gram capacity | 160.628 | mAh/g |
| Median voltage | 5.25 | v |
| D₅₀ | 1.51 | μm |

In embodiment four, the method can include the following steps.
1. 350 g of analytical-grade nickel oxalate monohydrate, 555.5 g of ammonium dihydrogen phosphate, and 1500 g of pure water are weighed. Then, 98.5 g of battery-grade manganese carbonate, 66.5 g of battery-grade lithium carbonate, 15 g of 5% graphene oxide slurry, 25 g of glucose, 23 g of PEG6000, and 10 g of high-efficiency surface active agent (a mixture of Allyl polypropylene glycol, Fatty alcohol and ethylene oxide, and Ether phosphate in a mass ratio of 4:3:2) are sequentially added into a 3000 L beaker. Sufficient stirring is performed for 10 min for dispersion.
2. The solid-to-liquid ratio of the above material is controlled at 40-45%, and the viscosity of the material is controlled at 4000-5000 Pa S. By controlling the pure water amount, the material is pumped into the sand mill for grinding. The particle size D₅₀ is controlled to be equal to 300 nm. The rotation speed of the main engine is set to 1500 r/min.
3. Spraying and drying are performed on the sand-milled slurry.
4. Sintering is performed on the material obtained in step 3 in the inert furnace protected by the high-purity N₂. The temperature of the low-temperature sintering is controlled at 450° C. and the temperature of the high-temperature sintering is controlled at 750° C. The temperature rising speed is controlled at 3° C./min.
5. The material of step 4 is crushed through the airflow, and the particle size D₅₀ is controlled at 1.55 μm. After sieving, grading, and packaging, 267.4 g of finished product of carbon-coated nickel-manganese lithium phosphate (LNMP/C) is obtained, i.e., LiMn_{0.5}Ni_{0.5}PO₄/C (with a nickel-to-manganese molar ratio of 5:5). This material can be measured with the carbon content, compaction, and electrical performance.
6. The LNMP/C powder material from step 5, PVDF, and conductive carbon black are mixed in a mass ratio of 95:5:5. The mixture is then dispersed and adjusted with a dispersing agent of N-methyl-2-pyrrolidone. To ensure uniform dispersion, strong dispersion is performed using a dual planetary mixer. The dispersed slurry is evenly coated onto a carbon-coated aluminum foil through a coating machine and then is dried.
7. The dried semi-finished electrode sheet obtained after drying is then extruded by a roller machine twice. The extruded electrode sheet is then cut into circular electrode sheets of Φ 18 mm using a punching machine, which are cathode sheets to facilitate assembly of button cell batteries.
8. The electrode sheets are assembled to form 2032 button cell batteries according to the requirements of simulated batteries button cell for electrical performance testing.

The obtained test results for the finished product are shown in the table below.

Embodiment four ICP Result

| | Measurement result |
|---|---|
| Element | (ppm) |
| Ca | 57.29 |
| Mg | 101.61 |
| Pb | 8.94 |
| Na | 109.27 |
| Cu | 5.42 |
| Cd | 1.68 |
| Zn | 15.57 |

Chemical Titration Analysis (%)

| Ni | 18.21 | |
|---|---|---|
| Ma | 17.01 | |
| Ni:Ma (Molar ratio) | 5:5 | |
| C % | 1.54% | |
| Li | 4.30% | |
| Powder compaction | 2.51 | g/cm³ |
| (3T 15 min) | | |
| 0.1 C gram capacity | 157.32 | mAh/g |
| Median voltage | 5.3 | v |
| D₅₀ | 1.55 | μm |

In embodiment five, the method can include the following steps.

The method and steps are same as the method and steps in embodiment one. The only difference includes that in step 1, 0.3 g of magnesium nitrate and 0.3 g of zinc nitrate are added additionally. Then, after all the materials are mixed, high-energy ball milling is performed on the mixture at 1200 r/min for 5 hours. Then, 327.58 g of the finished product of carbon-coated nickel-manganese lithium phosphate (LNMP/C) is obtained, i.e., LiMn_{0.4}Ni_{0.6}Mg_{0.01}Zn_{0.07}PO₄/C (with a nickel-to-manganese molar ratio of 6:4).

The obtained test results for the finished product are shown in the table below.

Embodiment Five ICP Result

| | Measurement result |
|---|---|
| Element | (ppm) |
| Ca | 34.72 |
| Mg | 459.84 |
| Pb | 6.9 |
| Na | 19.23 |
| Cu | 2.89 |
| Cd | 3.49 |
| Zn | 231.45 |

Chemical Titration Analysis (%)

| Ni | 21.72 | |
|---|---|---|
| Ma | 13.55 | |
| Ni:Ma (Molar ratio) | 6:4 | |
| C % | 1.54% | |
| Li | 4.28% | |
| Powder compaction | 2.46 | g/cm³ |
| (3T 15 min) | | |
| 0.1 C gram capacity | 159.88 | mAh/g |
| Median voltage | 5.18 | v |
| D₅₀ | 1.27 | μm |

In embodiment six, the method can include the following steps.

The method and steps are same as the method and steps in embodiment one. The only difference includes that in step 1, 0.5 g of vanadium pentoxide and 0.5 g of beryllium chloride are added additionally. Then, after all the materials are mixed, high-energy ball milling is performed on the mixture at 1200 r/min for 5 hours. Then, 371.99 g of the finished product of carbon-coated nickel-manganese lithium phosphate (LNMP/C) is obtained, i.e., LiMn_{0.4}Ni_{0.6}V_{0.022}Be_{0.012}PO₄/C (with a nickel-to-manganese molar ratio of 6:4).

The obtained test results for the finished product are shown in the table below.

Embodiment Six ICP Result

| | Measurement result |
|---|---|
| Element | (ppm) |
| Ca | 65.99 |
| Mg | 41.34 |
| Pb | 10.2 |
| Na | 71.41 |
| Cu | 2.89 |
| Cd | 3.49 |
| Zn | 3.45 |

Chemical Titration Analysis (%)

| Ni | 28.79 | |
|---|---|---|
| Ma | 6.73 | |
| Ni:Ma (Molar ratio) | 8:2 | |
| C % | 1.81% | |
| Li | 4.25% | |
| Powder compaction | 2.35 | g/cm³ |
| (3T 15 min) | | |
| 0.1 C gram capacity | 157.63 | mAh/g |
| Median voltage | 5.3 | v |
| D₅₀ | 1.34 | μm |

In embodiment seven, the method can include the following steps.

The method and steps are same as the method and steps in embodiment one. The only difference includes that in step 1, 1.5 g of cobalt chloride is added additionally. Then, after all the materials are mixed, high-energy ball milling is performed on the mixture at 1200 r/min for 5 hours. Then, 376.82 g of the finished product of carbon-coated nickel-manganese lithium phosphate (LNMP/C) is obtained, i.e., LiMn_{0.4}Ni_{0.6}Co_{0.15}PO₄/C (with a nickel-to-manganese molar ratio of 6:4).

The obtained test results for the finished product are shown in the table below.

Embodiment Seven ICP

[symbol]

| | Measurement result |
|---|---|
| Element | (ppm) |
| Ca | 10.74 |
| Mg | 23.87 |
| Pb | 15.53 |
| Na | 51.69 |
| Cu | 1.24 |
| Cd | 3.89 |
| Zn | 10.65 |

Chemical Titration Analysis (%)

| Ni | 25.31 | |
|---|---|---|
| Ma | 10.10 | |
| Ni:Ma (Molar ratio) | 7:3 | |
| C % | 1.46% | |
| Li | 4.27% | |
| Powder compaction | 2.27 | g/cm³ |
| (3T 15 min) | | |
| 0.1 C gram capacity | 160.628 | mAh/g |
| Median voltage | 5.25 | v |
| D₅₀ | 1.51 | μm |

In embodiment eight, the method can include the following steps.

The method and steps are same as the method and steps in embodiment two. The only difference includes that in step 1, 0.8 g of copper sulfate is added additionally. Then, after all the materials are mixed, the pH value is adjusted to 2.0-3.0. Then, 413.65 g of the finished product of carbon-coated nickel-manganese lithium phosphate (LNMP/C) is obtained, i.e., LiMn_{0.2}Ni_{0.5}Cu_{0.05}PO₄/C (with a nickel-to-manganese molar ratio of 8:2).

The obtained test results for the finished product are shown in the table below.

Embodiment Eight ICP Result

| | Measurement result |
|---|---|
| Element | (ppm) |
| Ca | 57.29 |
| Mg | 101.61 |
| Pb | 8.94 |
| Na | 109.27 |
| Cu | 5.42 |
| Cd | 1.68 |
| Zn | 15.57 |

Chemical Titration Analysis (%)

| Ni | 18.21 | |
|---|---|---|
| Ma | 17.01 | |
| Ni:Ma (Molar ratio) | 5:5 | |
| C % | 1.54% | |
| Li | 4.30% | |
| Powder compaction | 2.51 | g/cm³ |
| (3T 15 min) | | |
| 0.1 C gram capacity | 157.32 | mAh/g |
| Median voltage | 5.3 | v |
| D₅₀ | 1.55 | μm |

In embodiment nine, the method can include the following steps.

The method and steps are same as the method and steps embodiment two. The only difference includes that in step 1, lithium carbonate is added additionally to 143.7 g. Then, 412.1 g of the finished product of carbon-coated nickel-manganese lithium phosphate (LNMP/C) is obtained, i.e., Li_{1.025}Mn_{0.2}Ni_{0.5}PO₄/C (with a nickel-to-manganese molar ratio of 8:2).

The obtained test results for the finished product are shown in the table below.

Embodiment Nine ICP Result

| | Measurement result |
|---|---|
| Element | (ppm) |
| Ca | 34.72 |
| Mg | 59.84 |
| Pb | 6.9 |
| Na | 19.23 |
| Cu | 2.89 |
| Cd | 3.49 |
| Zn | 3.45 |

Chemical Titration Analysis (%)

| Ni | 21.72 | |
|---|---|---|
| Ma | 13.55 | |
| Ni:Ma (Molar ratio) | 6:4 | |
| C % | 1.54% | |
| Li | 4.38% | |
| Powder compaction | 2.46 | g/cm³ |
| (3T 15 min) | | |
| 0.1 C gram capacity | 159.88 | mAh/g |
| Median voltage | 5.18 | v |
| D₅₀ | 1.27 | μm |

In embodiment ten, the method can include the following steps.

The method and steps are same as the method and steps in embodiment three. The only difference includes that in step 3, lithium carbonate is added additionally to 136.54 g. Then, 381.32 g of the finished product of carbon-coated nickel-manganese lithium phosphate (LNMP/C) is obtained, i.e., Li_{1.035}Mn_{0.3}Ni_{0.7}PO₄/C (with a nickel-to-manganese molar ratio of 7:3).

The obtained test results for the finished product are shown in the table below.

Embodiment Ten ICP Result

| | Measurement result |
|---|---|
| Element | (ppm) |
| Ca | 65.99 |
| Mg | 41.34 |
| Pb | 10.2 |
| Na | 71.41 |
| Cu | 2.89 |
| Cd | 3.49 |
| Zn | 3.45 |

Chemical Titration Analysis (%)

| Ni | 28.79 | |
|---|---|---|
| Ma | 6.73 | |
| Ni:Ma (Molar ratio) | 8:2 | |
| C % | 1.81% | |
| Li | 4.35% | |
| Powder compaction | 2.35 | g/cm³ |
| (3T 15 min) | | |
| 0.1 C gram capacity | 157.63 | mAh/g |
| Median voltage | 5.3 | v |
| D₅₀ | 1.34 | μm |

In embodiment eleven, the method can include the following steps.

The method and steps are same as embodiment four. Only difference includes that in step 6, the obtained LNMP/C powder material, ternary material (622), PVDF, and conductive carbon black are mixed in a ratio of 80:10:5:5. Then, the mixture is then dispersed and adjusted. To ensure uniform dispersion, strong dispersion is performed using a dual planetary mixer. The dispersed slurry is evenly coated onto a carbon-coated aluminum foil through a coating machine and then is dried.

The obtained test results for the finished product are shown in the table below.

Embodiment Eleven ICP Result

| | Measurement result |
|---|---|
| Element | (ppm) |
| Ca | 10.74 |
| Mg | 23.87 |
| Pb | 15.53 |
| Na | 51.69 |
| Cu | 1.24 |
| Cd | 3.89 |
| Zn | 10.65 |

Chemical Titration Analysis (%)

| Ni | 25.31 | |
|---|---|---|
| Ma | 10.10 | |
| Ni:Ma (Molar ratio) | 7:3 | |
| C % | 1.46% | |
| Li | 4.37% | |
| Powder compaction | 2.27 | g/cm³ |
| (3T 15 min) | | |
| 0.1 C gram capacity | 160.628 | mAh/g |
| Median voltage | 5.25 | v |
| D₅₀ | 1.51 | μm |

In embodiment twelve, the method can include the following steps.

The method and steps are same as embodiment four. Only difference includes that in step 6, the obtained LNMP/C powder material, lithium manganate, PVDF, and conductive carbon black are mixed in a ratio of 75:15:5:5. Then, the mixture is then dispersed and adjusted. To ensure uniform dispersion, strong dispersion is performed using a dual planetary mixer. The dispersed slurry is evenly coated onto a carbon-coated aluminum foil through a coating machine and then is dried.

The obtained test results for the finished product are shown in the table below.

Embodiment Twelve ICP Result

| | Measurement result |
|---|---|
| Element | (ppm) |
| Ca | 57.29 |
| Mg | 101.61 |
| Pb | 8.94 |
| Na | 109.27 |
| Cu | 5.42 |
| Cd | 1.68 |
| Zn | 15.57 |

Chemical Titration Analysis (%)

| Ni | 18.21 | |
|---|---|---|
| Ma | 17.01 | |
| Ni:Ma (Molar ratio) | 5:5 | |
| C % | 1.54% | |
| Li | 4.30% | |
| Powder compaction | 2.51 | g/cm³ |
| (3T 15 min) | | |
| 0.1 C gram capacity | 157.32 | mAh/g |
| Median voltage | 5.3 | v |
| D₅₀ | 1.55 | μm |

Furthermore, the technical features described above can be combined in any suitable manner when there is no conflict. To avoid unnecessary repetition, the combinations are not repeated in the present disclosure.

Embodiments are merely some embodiments for describing the present disclosure. The scope of the present invention is not limited thereto. Those skilled in the art can make various equivalent replacements or modifications based on the present disclosure. The modifications and replacements are within the scope of the present disclosure. The scope of the present invention is subjected to the claims.

What is claimed is:

1. An olivine-structured nickel manganese phosphate active material comprising:
a general structural formula of Ni_{b}Mn_{d}MₑPO₄, wherein:
b is greater than or equal to 0.1 and greater than or equal to 0.95;
d is greater than or equal to 0.05 and greater than or equal to 0.90;
e is greater than or equal to 0 and greater than or equal to 0.5; and
a doping element M includes one or a combination of Fe, Al, Co, Ca, Pb, Na, Ti, Zr, Mo, V, Nb, Sc, Cr, Cu, Zn, Be, La, Mg, N, or S.

2. The active material according to claim 1, wherein in the general structural formula of Ni_{b}Mn_{d}MₑPO₄, b ranges from 0.1 to 0.95, d ranges from 0.05 to 0.9, and e is greater than or equal to 0 and greater than or equal to 0.5.

3. The active material according to claim 2, wherein in the general structural formula of Ni_{b}Mn_{d}MₑPO₄, b ranges from 0.5 to 0.8, d ranges from 0.2 to 0.5, and e is greater than or equal to 0 and greater than or equal to 0.5.

4. The active material according to claim 3, wherein in the general structural formula of Ni_{b}Mn_{d}MₑPO₄, b is 0.5, 0.6, 0.7, or 0.8, d is 0.2, 0.3, 0.4, or 0.5, and e is 0, 0.05, 0.1, or 0.15.

5. The active material according to claim 4, wherein in the general structural formula of Ni_{b}Mn_{d}MₑPO₄:
b is 0.8, d is 0.2, and e is 0.05, 0.1, or 0.15;
b is 0.7, d is 0.3, and e is 0.05, 0.1, or 0.15;
b is 0.6, d is 0.4, and e is 0.05, 0.1, or 0.15; or
b is 0.5, d is 0.5, and e is 0.05, 0.1, or 0.15.

6. The active material according to claim 5, further comprising the structural formula including Ni_{0.8}Mn_{0.2}M_{0.05}PO₄, Ni_{0.8}Mn_{0.2}M_{0.1}PO₄, Ni_{0.8}Mn_{0.2}M_{0.15}PO₄, Ni_{0.7}Mn_{0.3}M_{0.05}PO₄, Ni_{0.7}Mn_{0.3}M_{0.1}PO₄, Ni_{0.7}Mn_{0.3}M_{0.15}PO₄, Ni_{0.6}Mn_{0.4}M_{0.05}PO₄, Ni_{0.6}Mn_{0.4}M_{0.1}PO₄, Ni_{0.6}Mn_{0.4}M_{0.15}PO₄, Ni_{0.5}Mn_{0.5}M_{0.05}PO₄, Ni_{0.5}Mn_{0.5}M_{0.1}PO₄, or Ni_{0.5}Mn_{0.5}M_{0.15}PO₄, wherein M includes any one of Fe, Co, Ca, Pb, Na, Ti, Zr, Mo, V, Nb, Sc, Cr, Cu, Zn, Be, La, or Mg

7. The active material according to claim 6, wherein a manganese source includes one or a combination of manganese monoxide, manganese dioxide, manganese tetroxide, manganese carbonate, manganese citrate, manganese acetate, manganese oxalate, manganese sulfate, manganese nitrate, or manganese chloride.

8. The active material according to claim 7, wherein a nickel source includes one or a combination of elemental nickel, nickel hydroxide, nickel sulfate, nickel oxalate, nickel carbonate, nickel nitrate, or nickel chloride.

9. The active material according to claim 8, wherein a source of a doping element M includes one or a combination of sulfates, phosphates, nitrates, chlorides, oxalates, acetates, carbonates of any one of Fe, Co, Ca, Pb, Na, Ti, Zr, Mo, V, Nb, Sc, Cr, Cu, Zn, Be, La, or Mg.

10. The active material according to claim 9, wherein a particle size of the active material D50 ranges from 0.5 to 2.0 μm, from 1.0 to 1.6 μm, or from 1.2 to 1.55 μm.

11. A carbon-coated lithium nickel-manganese phosphate composite material comprising a structural formula of LiₐNi_{b}Mn_{d}MₑPO₄/C including the structural formula of the olivine-structured nickel manganese phosphate active material according to claim 1, wherein:
a ranges from 0.01 to 1.05; and
a ratio of a sum of (a+b+d+e) and a molar value of PO₄³⁻ ranges from 0.90 to 1.05.

12. The composite material according to claim 11, wherein:
a ranges from 1.025 to 1.035 or includes any one of 1.025, 1.026, 1.027, 1.028, 1.029, 1.030, 1.031, 1.032, 1.033, 1.034, or 1.035, and a carbon content is 1-3%; and
in response to a ranging from 0 to 1.025, pre-lithiated nickel manganese phosphate or pre-cursor material nickel manganese phosphate is be obtained.

13. The composite material according to claim 12, wherein a carbon source includes one or a combination of organic carbon, artificial or natural graphite, graphene, carbon nanotubes or Super P, acetylene black, or another conductive carbon, and the carbon content is 0.1-10%.

14. A preparation method of an olivine-structured nickel manganese phosphate active material comprising:
adding a manganese source, a nickel source, a phosphorus source, and a source of a doping element proportionally according to stoichiometry to obtain a mixture;
grinding and dispersing the mixture in a sand mill;
after a particle size satisfying a requirement, performing spraying and drying to obtain a dry material; and
performing sintering on the dry material for dehydration and phase change to obtain the nickel manganese phosphate material; or
adding the manganese source, the nickel source, a lithium source, a carbon source, the phosphorus source, and the source of a doping element proportionally according to stoichiometry to obtain a mixture;
grinding and dispersing the mixture in the sand mill;
after a particle size satisfying the requirement, performing spraying and drying to obtain a dry material; and
performing sintering on the dry material for dehydration and phase change to obtain the carbon-coated lithium nickel manganese phosphate material.

15. The method according to claim 14, wherein:
the manganese source includes one or a combination of manganese monoxide, manganese dioxide, manganese tetroxide, manganese carbonate, manganese citrate, manganese acetate, manganese oxalate, manganese sulfate, manganese nitrate, or manganese chloride;
the nickel source includes one or a combination of elemental nickel, nickel hydroxide, nickel sulfate, nickel oxalate, nickel carbonate, nickel nitrate, or nickel chloride;
the lithium source includes one or a combination of lithium carbonate, lithium bicarbonate, lithium sulfate, lithium phosphate, lithium oxalate, and lithium hydroxide;
the phosphorus source includes one or a combination of ammonium phosphate, lithium phosphate, sodium phosphate, phosphoric acid, or metaphosphoric acid;
the source of the doping element M includes one or a combination of sulfates, phosphates, nitrates, chlorides, oxalates, acetates, carbonates of any one of Fe, Co, Ca, Pb, Na, Ti, Zr, Mo, V, Nb, Sc, Cr, Cu, Zn, Be, La, or Mg; and
the carbon source includes one or a combination of organic carbon, synthesized or natural graphite, graphene, carbon nanotubes or Super P, acetylene black or another conductive carbon, PEG, or glucose.

16. The method according to claim 15, further comprising:
adding water to the mixture to adjust the mixture to a slurry after mixing the manganese source, the nickel source, the phosphorus source, and the source of the doping element, or after mixing the manganese source, the nickel source, the lithium source, the carbon source, the phosphorus source, and the source of the doping element;
adding a surface active agent;
heating to raise a temperature to 90-120° C. to perform reaction for 2-4 h;
after the reaction, performing filtering to obtain a filter cake of lithium nickel manganese phosphate; and
performing ball milling after drying the filter cake.

17. The method according to claim 16, wherein the surface active agent is a mixture formed by Allyl polyethylene glycol, Polyvinylpyridine, and Polyvinylpyrrolidone (PVP) in a mass ratio of 4:(2-3):(0.5-2).

18. The method according to claim 17, further comprising:
adding the carbon source and the lithium source in a ball milling process to cause a molar value of lithium in an obtained structural formula of LiₐNi_{b}Mn_{d}MₑPO₄/C to range from 0.01 to 1.05 and the carbon content to range from 0.1 to 10%;
adjusting a solid-to-liquid ratio to 40-45%;
controlling a viscosity at 4000-5000 Pa·S; and
performing the spraying and drying after milling to cause the particle size to be 200-800 nm.

19. The method according to claim 18, wherein:
the requirement of the particle size D50 of a single material is within 200 nm or 100 nm;
the particle size D50 of the sand milling is controlled to be 0.2-0.8 μm;
the particle size of the product after performing the spraying and drying ranges from 15 to 25 μm or from 10 to 15 μm; and
a carbon-coated sintering temperature includes that a temperature of a low-temperature coke discharge stage is set to 250-650° C. or 400-500° C., and a temperature of a high-temperature phase change state is set to 680-800° C. or 700-790° C.

20. A preparation method of an olivine-structured nickel manganese phosphate active material comprising:
fully dissolving a manganese source and a nickel source in a water solution of a phosphorus source for reaction;
adding an alkaline material to adjust a pH value to 2˜10;
performing precipitation and crystallization;
filtering a slurry after the crystallization to obtain a filter cake and cleaning the filter cake with pure water; and
performing drying and sintering on the filter cake to obtain the olivine-structured nickel manganese phosphate active material.
